(19) United States
(12) Patent Application Publication
(10) Pub. No.: US 2003/0052309 A1
(43) Pub. Date: Mar. 20, 2003

(54) Nano-tube of multi-element system oxide

(75) Inventors: Kazuaki Sajiki, Hiratsuka (JP); Yoshiyuki Niwatsukino, Hiratsuka (JP); Satoshi Tanda, Sapporo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KOMATSU LIMITED, Tokyo (JP)

(21) Appl. No.: 10/245,572

(22) Filed: Sep. 17, 2002

(30) Foreign Application Priority Data
Sep. 19, 2001 (JP) 2001-284477

(51) Int. Cl. H01B 1/00; H01C 1/00

(52) U.S. Cl. 252/500

(57) ABSTRACT

A nano-tube of multi-element system oxide having novel characteristics and expected to gain application to a variety of devices includes a multi-element system oxide containing at least one of Bi, Y, La and Sc as a component thereof and having a tube diameter of less than 1×10⁻⁶ m.

### BACKGROUND OF THE INVENTION

1. Field of the Invention

This invention relates to a nano-tube formed of a multi-element system oxide as its material and having a tube diameter of less than 1×10⁻⁶ m.

2. Description of a Related Art

Multi-element system oxides include those materials which have properties of superconductor, ferromagnetic substance and ferroelectric substance. Metal oxide system superconductor materials among them are novel high-temperature superconductor materials for which researches have now been made vigorously in various countries in the world. Reports have been filed about constituent materials of various superconductor materials and compositions thereof to raise a zero resistance point of a critical transition temperature (Tc) to a higher temperature. Examples of such superconductor materials are multi-element system oxides such as a Y—Ba—Cu—O system, a La—Ba—Cu—O system, a La—Sr—Cu—O system, an Sc—Ba—Cu—O system and a Bi system.

Thin films of the multi-element system oxides have been formed in the past by methods such as CVD (Chemical Vapor Deposition), sputtering and PLD (Pulsed Laser Deposition) Japanese Patent Application Laid-Open JP-A-2-196098, for example, discloses a method of forming a thin film of an oxide high-temperature superconductor by blasting an oxygen-containing high-temperature gas simultaneously with irradiation of a laser beam. The thin film has been used as wiring and devices in integrated circuits.

Takeshi SASAKI et al. “Preparation of Metal Oxide Nanoparticles by Laser Ablation”, Laser Review June 2000, p. 348-353 describes a method of preparing nano-micro-particles of metal oxides by laser ablation. The micro-particles of the metal oxides have extremely unique physical and chemical properties when compared with bulk materials. Magnetic oxide nano-micro-particles of iron and cobalt oxides, for example, have magnetic properties such as super-paramagnetic property and quantum tunnel magnetization, and their application to magnetic recording, magnetic fluids and medical fields have been expected. A nano-face sensor utilizing a high-density interface of the nano-micro-particles is another field of the expected application.

On the other hand, Fumio KOKAI et al. “Synthesis of Single-Wall Carbon Nanotubes by Laser Vaporization and Its Dynamic Process”, Laser Review June 2000, p. 342-347 discloses a method of synthesizing a single-layered carbon nano-tube by laser evaporation. The carbon nano-tube is a cylindrical substance including a single atom layer of graphite, and the carbon nano-tubes having a multi-layered structure and a single-layered structure are known. It is also known that kaolin (Al₂SiO₅) as a member of the same group as mica has a ring crystal.

However, the multi-element system oxides assuming the nano-tube form have not yet been produced. If the nano-tube of the multi-element system oxides can be accomplished, the possibility is extremely high that novel properties are discovered, and the application to various electronic devices and expansion of the application to various other fields are expected. It will be possible to produce, for example, superconductor tubes having a diameter of less than hundreds of nanometers, micro-SQUID (a kind of magnetic sensors utilizing a quantum interference effect) and nano-superconductor devices.

### SUMMARY OF THE INVENTION

With the background described above, the invention is directed to provide a nano-tube of a multi-element system oxide which has novel properties and application of which is expected to a variety of devices.

According to a first aspect of the invention for accomplishing the object, there is provided a nano-tube including a multi-element system oxide containing at least one of Bi, Y, La and Sc as a component thereof, and having a tube diameter of less than 1×10⁻⁶ m. The nano-tube according to the invention is a novel substance that has not existed in the past, and its application is expected to low power consumption integrated circuits, magnetic recording, magnetic fluids, large capacity memories and medical fields by utilizing its properties as superconductor, ferromagnetic substance or ferroelectric substance.

According to a second aspect of the invention, a nano-tube is produced by conducting laser ablation by using pulse laser in a gas atmosphere having a pressure of 0.1 atm or more with a multi-element system oxide having a laminar two-dimensional structure as a target, and a tube diameter is less than 1×10⁻⁶ m. The nano-tube expected to provide the novel properties can be easily formed by such a laser ablation method.

In the nano-tube according to the invention, the multi-element system oxide may be a selected one of a group including a Bi—Pb—Sr—Ca—Cu—O system, a Bi—Sr—Ca—Cu—O system, a Bi—Sr—Cu—O system, a Bi—Pb—Sr—Cu—O system, a Y—Ba—Cu—O system, a La—Ba—Cu—O system, a La—Sr—Cu—O system and an Sc—Ba—Cu—O system. Nano tubes having different properties are expected depending on the selection of the multi-element system oxides.

In the case where the laser ablation is conducted, a gas temperature is preferably within a range from 0° C. to 40° C. This temperature can be easily set and a production process becomes easier to carry out. In the laser ablation, a pulse time width of the pulse laser is preferably 1×10⁻⁶ sec or below. When a laser beam having such a pulse time width is irradiated, a target surface can be strongly excited within a short time.

### BRIEF DESCRIPTION OF THE DRAWINGS

FIG. 1 shows a crystal structure of a target used for producing a nano-tube of a multi-element system oxide according to an embodiment of the invention;

FIG. 2 is a view useful for explaining a production method and a production apparatus of a nano-tube of a multi-element system oxide according to the embodiment of the invention;

FIG. 3 is a TEM photograph of a nano-tube of a multi-element system oxide obtained in the embodiment of the invention; and

FIG. 4 is a photograph showing a diffraction pattern of the nano-tube of the multi-element system oxide obtained in the embodiment of the invention.

### DESCRIPTION OF THE PREFERRED EMBODIMENTS

Preferred embodiments of the invention will be explained in detail with reference to the accompanying drawings.

A nano-tube according to an embodiment of the invention is formed by conducting laser ablation by use of a multi-element system oxide having a laminar two-dimensional structure as a target.

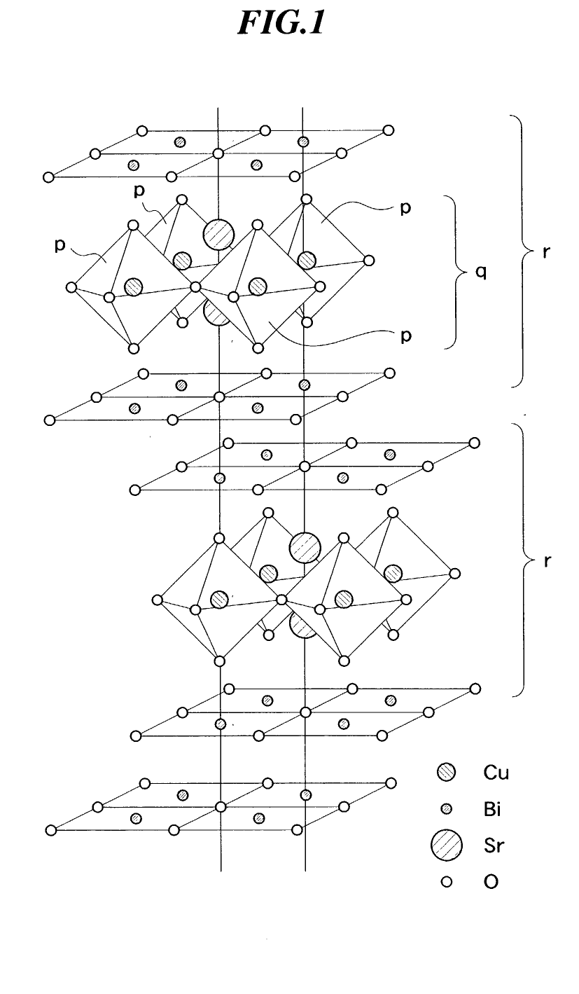

The laminar two-dimensional structure corresponds to those which include a so-called “laminar perovskite structure”. An example of the laminar two-dimensional structure including the laminar perovskite structure will be explained with reference to FIG. 1. FIG. 1 shows a crystal structure of a Bi—Sr—Cu—O system multi-element system oxide. Six oxygen atoms encompass a Cu atom to form an octahedral perovskite structure “p”. Two Sr atoms are arranged at the center of four perovskite structures arranged in a ring form in such a fashion as to coincide with a center axis of the ring. BiO planes formed of Bi atoms and O atoms are arranged in such a fashion as to sandwich from above and below a structure “q” constituted by four perovskite structures “p” and two Sr atoms. A plurality of structural units “r” having BiO planes above and below the structure “q” are arranged to be alternately deviated from one another in a longitudinal direction in the drawing to constitute the laminar perovskite structure. Here, the BiO planes overlap with each other at the boundary of the two adjacent structural units “r”. However, these BiO planes are bonded by a weak van der Waals force and the structure is likely to peel in a laminar form from the BiO planes.

The principle of the formation of the nano-tube in this embodiment is presumably as follows. The laminar two-dimensional structure peels in the laminar form from the BiO planes described above due to energy applied from outside into a sheet-like material, and this sheet-like material curls and its ends bond with each other to form the nano-tube.

The term “multi-element system oxide” represents those oxides which contain at least two kinds of atoms and oxygen, and examples include a Y—Ba—Cu—O system, a La—Ba—Cu—O system, a La—Sr—Cu—O system, an Sc—Ba—Cu—O system and a Bi system.

Typical examples of the Bi system material having the laminar perovskite structure are a Bi-2223 system (Bi₂Sr₂Ca₂Cu₃O₁₀), a Bi-2212 system (Bi₂Sr₂Ca₁Cu₂O₈) and a Bi-2201 system (Bi₂Sr₂CuO₆). The superconduction transition temperature is 120K for the Bi-2223 system and 85K for the Bi-2212 system. The Bi-2201 system does not undergo transition. These materials may be doped with Pb to improve thermal stability to high temperatures.

This embodiment employs the laser ablation process using pulse laser with the multi-element system oxide described above as a target. The term “laser ablation” represents a phenomenon in which a material absorbing beam energy is explosively evaporated and gasified when a surface of a target at a condenser portion is brought into a high-temperature molten state by condensing the laser beam to the target and gaseous particles (excitation atoms, excitation molecules andions) are emitted. The gaseous particles so emitted create a high-temperature high-pressure state and emit light. This light emission portion is called as “plume”. The gaseous particles further impinge against the atmosphere gas, are cooled and condensed, adhere to and are deposited on the surface of a substrate, so as to form micro-particles such as a thin film. A method of forming the micro-particles such as a thin film by utilizing laser ablation is called the “laser ablation process”.

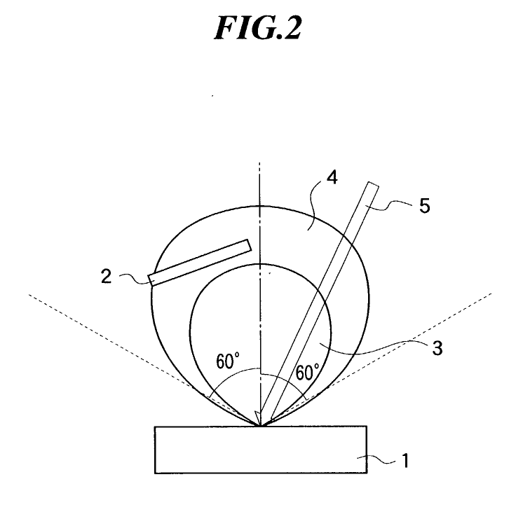

Next, a production method of a nano-tube according to the embodiment will be explained in detail with reference to FIG. 2.

A target 1 and a sample substrate 2 are arranged with a predetermined positional relationship as shown in FIG. 2. The target 1 contains as its component a multi-element oxide having a laminar two-dimensional structure. A pulse-like laser beam 5 is irradiated from an oblique direction to the target 1 by use of pulse laser and gaseous particles are emitted from the target 1. The gaseous particles so emitted form a plume 3 as a light emission portion under a high-temperature high-pressure state. The gaseous particles are cooled while impinging against the atmosphere gas outside the plume 3, forming an aggregation region 4. The sample substrate 2 exists inside this aggregation region 4, and the gaseous particles so aggregated adhere and are deposited to the surface of the sample substrate 2.

When the gaseous particles as the material gas exist in a sufficient density, these micro-particles further aggregate at a high temperature and form the nano-tube. In the formation process of the nano-micro-particles by the laser ablation process using the multi-element system oxide as a target, the laminar two-dimensional structures peel in the laminar form to the sheet-like material as shown in FIG. 1. Since the chemical species such as the atoms and the molecules generated by laser ablation grow in the atmosphere gas, the sheet-like material curls and its ends bond with each other, thereby forming the nano-tube. The diameter of the nano-tube formed in this way is less than 1×10⁻⁶ m.

The atmosphere gas diffuses the nano-tube thus formed to a considerably broad range. Therefore, the installation position of the sample substrate 2 has high freedom for recovering the resulting nano-tube, and an optimum position is preferably decided while collection efficiency of the nano-tube and material characteristics are taken into account. When the installation position of the sample substrate 2 is too close to the laser irradiation position in the target 1, for example, the gaseous particles adhere and are deposited to the surface of the sample substrate 2 while they remain under the micro-particle state. In this case, the nano-tube is not formed, or the nano-tube that is once formed receives thermal damage and is broken. Concretely, the distance between the sample substrate 2 and the laser irradiation position is preferably within the range of 5 cm to 20 cm. Further, the sample substrate 2 preferably exists at a position within 60 degrees from the normal at the laser irradiation position.

The production method described above can use KrF excimer laser, ArF excimer laser or F₂ (fluorine molecule) laser as the pulse laser. Here, to strongly excite the target surface within a short time, the pulse time width of the laser beam is preferably 1 μs (1×10⁻⁶ sec) or below. The repetition frequency of the pulse is preferably 1 Hz to 50 Hz.

In this embodiment, the gas atmosphere in which the reaction is carried out is open air (air as the gas species with a gas pressure of about 1 atm and a reaction temperature at room temperature), but laser ablation may be carried out within an atmosphere containing a predetermined gas species. Examples of such a predetermined gas species are oxygen, nitrogen and carbon dioxide. However, when laser ablation is carried out inside the predetermined gas species, a gas vessel fully covering the apparatus shown in FIG. 2 becomes necessary. To increase the number of impingement between the gaseous particles and the atmosphere gas, the pressure of the atmosphere gas is preferably 0.1 atm or more. When the strength of the gas vessel is taken into account, on the other hand, the pressure of the gas atmosphere is preferably 10 atm or below. The temperature of the atmosphere gas is preferably from 0° C. to 40° C.

(Example)

The invention will be concretely explained with reference to Example thereof.

A single crystal of Bi_{1.9}Pb_{0.2}Sr_{1.9}CuO₆ prepared by doping Bi₂Sr₂CuO₆ with Pb was formed as a material of a target by a self-flux method using, as a flux, CuO containing in excess powder of raw materials milled and mixed in a crucible. Because Bi₂Sr₂CuO₆ is unstable to a high temperature during the crystal formation process, Pb was doped to improve stability. The target has a diameter of about 10 mm and a thickness of about 3 mm. This target was installed in open air as shown in FIG. 2. The temperature was about 25° C. close to the room temperature.

The sample substrate was a micro-grid mesh (hereinafter called the “TEM mesh”) for transmission electron microscope (TEM) observation. The TEM mesh was installed at a position of 5 cm to 20 cm above the target at an angle of 45 degrees from a laser irradiation optical axis.

A pulse-like laser beam was irradiated to the target surface by using KrF excimer laser to conduct laser ablation. Here, the laser beam had a wavelength of 248 nm, a pulse time width of 30 ns (HWHM) and a pulse repletion frequency of 10 Hz. A laser beam of about 3,000 pulses was irradiated in the course of 5 minutes. The intensity of the laser beam incident to the target surface was 800 mJ/cm².

When TEM observation of the sample substrate was made after the execution of laser ablation, adhesion of the multi-element system oxide was recognized at all positions on the sample substrate. It was thus confirmed that the nano-tube grown in the atmosphere gas is diffused to a broad range. However, a collection amount of the multi-element system oxide varied depending on the distance from the laser irradiation position. The TEM mesh was partially broken at positions close to the target. This is presumably because the gaseous particles were under the high-temperature state in the proximity of the target and imparted thermal damage to the TEM mesh.

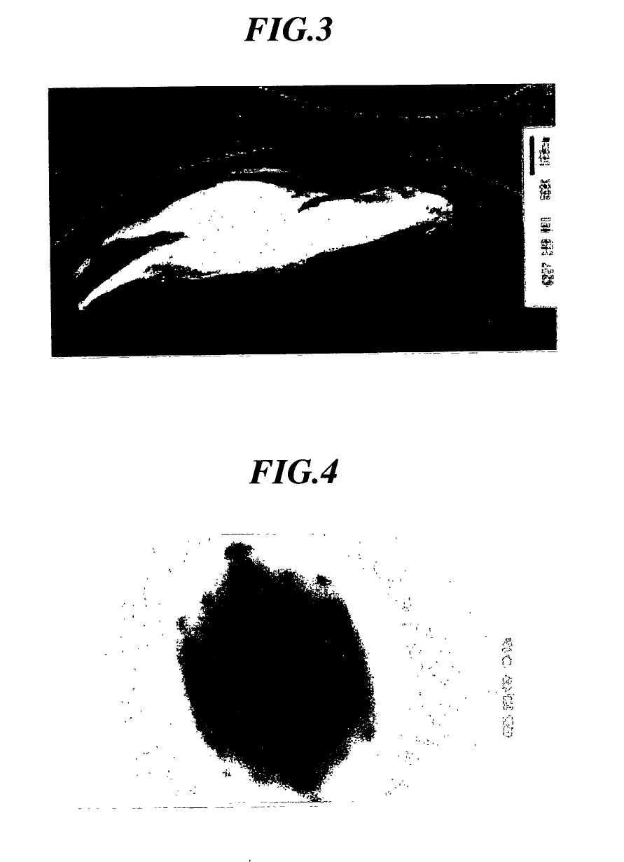

FIG. 3 shows a TEM photograph of the multi-element system oxide adhering to the sample substrate. In FIG. 3, it is confirmed that a thinly elongated object having a length of about 1 μm and a thickness of about 200 nm was imaged.

FIG. 4 shows an electron beam diffraction pattern of the inverse lattice image of the multi-element system oxide adhering to the same substrate. It can be confirmed from this electron beam diffraction pattern that the multi-element system oxide is a single crystal. Further, in this electron beam diffraction pattern, a line extending from the upper left to the lower right in the drawing can be confirmed in a direction vertical to the longitudinal direction of the thinly elongated object. This represents the same feature as that of the diffraction pattern in a carbon nano-tube (CNT) and is peculiar to a tube. Therefore, it is possible to estimate that the multi-element system oxide adhering to the sample substrate is a tube.

1. A nano-tube including a multi-element system oxide containing at least one of Bi, Y, La and Sc as a component thereof, and having a tube diameter of less than 1×10⁻⁶ m.

2. A nano-tube formed by conducting laser ablation by using pulse laser in a gas atmosphere having a pressure of not less than 0.1 atm with a multi-element system oxide having a laminar two-dimensional structure as a target, and having a tube diameter of less than 1×10⁻⁶ m.

3. A nano-tube according to claim 1, wherein said multi-element system oxide is a selected one of a group including a Bi—Pb—Sr—Ca—Cu—O system, a Bi—Sr—Ca—Cu—O system, a Bi—Sr—Cu—O system, a Bi—Pb—Sr—Cu—O system, a Y—Ba—Cu—O system, a La—Ba—Cu—O system, a La—Sr—Cu—O system and a Sc—Ba—Cu—O system.

4. A nano-tube according to claim 2, wherein said multi-element system oxide is a selected one of a group including a Bi—Pb—Sr—Ca—Cu—O system, a Bi—Sr—Ca—Cu—O system, a Bi—Sr—Cu—O system, a Bi—Pb—Sr—Cu—O system, a Y—Ba—Cu—O system, a La—Ba—Cu—O system, a La—Sr—Cu—O system and a Sc—Ba—Cu—O system.

5. A nano-tube according to claim 2, wherein a gas temperature in said laser ablation is within a range from 0° C. to 40° C.

6. A nano-tube according to claim 2, wherein a pulse time width of the pulse laser in said laser ablation is not larger than 1×10⁻⁶ sec.

7. A nano-tube according to claim 5, wherein a pulse time width of pulse laser in said laser ablation is 1×10⁻⁶ sec or below.
